(19) United States
(12) Patent Application Publication
(10) Pub. No.: US 2015/0054228 A1
(43) Pub. Date: Feb. 26, 2015

(54) GASKET

(71) Applicant: UCHIYAMA MANUFACTURING CORP., Okayama (JP)

(72) Inventors: Katsunori Matsuki, Okayama (JP); Kenji Hamano, Okayama (JP); Yoshihiko Yamaguchi, Okayama (JP); Satoshi Miyazaki, Okayama (JP); Takanobu Arakawa, Okayama (JP); Kuniyuki Doi, Aichi (JP); Takashi Miyake, Okayama (JP)

(21) Appl. No.: 14/384,240

(22) PCT Filed: Mar. 5, 2013
(86) PCT No.: PCT/JP2013/055985

§ 371 Date: Sep. 10, 2014

(30) Foreign Application Priority Data
Mar. 15, 2012 (JP) 2012-058829

(51) Int. Cl. F02F 11/00

(52) U.S. Cl. CPC F02F 11/002
USPC 277/598

(57) ABSTRACT

A gasket provided between two members for sealing a space therebetween. The gasket comprises a plurality of annular seal parts and a coupling part for coupling the annular seal parts. At least one of the annular seal parts and the other annular seal parts to be coupled with the one annular seal part are made of different materials, and the coupling part for coupling the annular seal parts made of different materials has a joint part for jointing the different materials.

### TECHNICAL FIELD

The present invention relates to a gasket provided between two members and sealing a space therebetween, the gasket having a plurality of annular seal parts connected with each other.

### BACKGROUND ART

When there are a plurality of annular objective regions to be sealed on one plane, one gasket is formed by coupling the annular seal parts of objective regions, referring to PTL (Patent Literature) 1 to PTL 4. FIG. 6 of PTL 1 shows a seal ring formed by coupling annular parts (annular seal parts), with straight parts, for sealing each cylinder of a rocker cover of an automobile engine. PTL 2 discloses a gasket integrally formed with a plurality of gasket bodies (annular seal parts) and coupling parts for coupling the gasket bodies. In addition, FIG. 15 of PTL 3 discloses an O-ring of integral type formed by coupling adjacent O-rings (annular seal parts) with coupling parts, the O-rings being mounted on a seal mounting groove around a cooling water outlet on the housing side, a cooling water inlet on the housing side, an oil outlet on the housing side, and an oil inlet on the housing side, respectively. PTL 4 discloses a gasket for a cylinder head cover formed by coupling an external seal part (an annular seal part) and a plug seal part (annular seal part), the external seal part being provided on a joint part of an external wall of a cylinder head and an external wall of the cylinder head cover, the plug seal part being provided on a joint part thereof on a plug storage wall.

### CITATION LIST

### Patent Literature

### PTL 1 Japanese Patent Unexamined Publication No. 8-246952

### PTL 2 Japanese Patent No. 4400699

### PTL 3 Japanese Patent No. 4425885

### PTL 4 Japanese Patent Unexamined Publication No. 2006-144654

### SUMMARY OF INVENTION

### Technical Problem

In addition to the above-mentioned ones, one cylinder head gasket can be constituted by coupling, with a coupling part, an annular seal part around a cylinder bore, an annular seal part around a communication bore for a cooling medium (antifreeze liquid) and an annular seal part around a communication bore for engine oil. When a plurality of annular seal parts are constituted as one gasket, parts control is facilitated and assembly efficiency is improved, thereby such a gasket is strongly desired by consumers. When a gasket formed by coupling, with a coupling part, a plurality of annular seal parts for a plurality of objective regions to be sealed is integrally molded with a rubber material, for example, the whole body is required to be formed with one rubber material suitable for a region which requires the highest quality, around a cylinder bore in this example. Such high quality is not required for other regions and the gasket may cost more than a gasket which is separately produced with a rubber material suitable for each objective region to be sealed.

A plurality of annular parts of the seal ring disclosed by PTL 1 are for sealing each cylinder of the rocker cover. The quality of the annular parts required for each cylinder is the same, so that the above-mentioned excessive quality problem does not occur even when the gasket is integrally formed with the same rubber material. A plurality of gasket bodies of the gasket disclosed by PTL 2 are supposed to be provided under the same condition. Therefore, when the gasket is integrally formed with the same rubber material as in PTL 1, there are no excessive quality parts. The O-rings disclosed by PTL 3 are for sealing the inlet and the outlet for cooling water, and the inlet and the outlet for oil of the housing. When the quality of rubber suitable for oil as an objective medium to be sealed is different from that for cooling water and the whole body is integrally formed with a rubber material of high quality suitable for an objective medium to be sealed requiring high quality, the quality for one objective medium to be sealed becomes excessive for that of the other. Therefore, there is a problem of high cost as mentioned above; however, PTL 3 neither mentions such a problem nor suggests a solution. The gasket disclosed by PTL 4 is provided at the joint part of the cylinder head and the cylinder head cover wherein two kinds of annular seal parts (the external seal part and the plug seal part) have a coupling part, respectively and the coupling parts are coupled with each other. The PTL 4 discloses that two kinds of annular seal parts are separately produced without disclosing the difference between the qualities required for the annular seal parts.

The present invention is proposed in view of the above-mentioned problems. The object of the present invention is to provide a gasket with a simple structure wherein a plurality of annular seal parts requiring different qualities are constituted with a material suitable for the quality, respectively, and are integrated for facilitating assembly.

### Solution to Problem

A gasket of the present invention is provided between two members and configured to seal a space therebetween. The gasket comprises a plurality of annular seal parts and a coupling part configured to couple the annular seal parts. At least one of the annular seal parts is made of different material from that of the other annular seal parts coupled with the one annular seal part. The coupling part is configured to couple the annular seal parts made of different materials and has a joint part configured to joint the different materials.

A plurality of annular seal parts are coupled by the coupling part, so that assembly is facilitated and done effectively, compared with the case wherein a plurality of gaskets are assembled to the objective regions to be sealed, respectively. In addition, one gasket including a plurality of annular seal parts for a plurality of objective regions to be sealed is able to be effectively produced, thereby facilitating production control and conveyance, compared with the case wherein gaskets are produced for the objective regions to be sealed, respectively. At least one annular seal part of the above-mentioned plurality of annular seal parts is constituted with material different from that of other annular seal parts connected to one annular seal part, so that a suitable material is able to be selected for each objective medium to be sealed and excessive quality problem does not occur, thereby reducing production cost. The coupling part for coupling the annular seal parts constituted with different materials has the joint part for jointing the different materials. The coupling part is provided at a region which does not affect seal performance, so that it does not affect long-term seal performance.

In the present invention, the annular seal parts made of different materials can be of different exterior colors. In the above-mentioned embodiment, when the colors of the annular seal parts are different corresponding to objective medium to be sealed, respectively, the corresponding position for assembly is able to be confirmed, so that assembly is facilitated and done effectively.

In the present invention, the coupling part configured to couple the annular seal parts made of different materials can comprise a pair of coupling pieces extending from each annular seal part and the joint part configured to joint the coupling pieces. The above-mentioned coupling pieces extend from each annular seal part, so that they are able to be integrally constituted with each annular seal part using the same material by molding. The coupling pieces made of different materials are jointed and constitute the joint part. Such a joint part is provided at a region which does not affect seal performance, namely a region apart from each annular seal part, so that it does not affect the seal performance of the joint part.

In the present invention, the joint part can be made of a material different from that of the coupling pieces. In the above-mentioned embodiment, the joint part is provided at a region which does not affect seal performance. A material with high joint strength is able to be used for the joint part without considering seal ability, thereby enhancing the strength of the joint part without deteriorating seal ability.

In the present invention, the pair of coupling pieces can be jointed with a larger area than the sectional area of the coupling piece.

In this embodiment, when the adjacent annular seal parts made of different materials are simultaneously molded, the joint strength is further enhanced because the joint area of the joint part is large.

In the present invention, the pair of coupling pieces can have constricted parts, respectively, the constricted parts facing each other relative to the joint part and being provided close to the joint part.

In the above-mentioned embodiment, the constricted part is provided for the facing sides of the coupling pieces close to the joint part, respectively. The stress applied on the coupling part concentrates on the constricted part and the stress applied on the joint part is alleviated, thereby improving the durability of the joint part.

In the present invention, the coupling part can be formed with an enlarged part, the enlarged part being larger than the coupling pieces in the sectional area.

In the above-mentioned embodiment, the joint area is increased by the enlarged part. In addition, in case of a simultaneous molding, the flow strength of material is alleviated and the material of one annular seal part is inhibited from entering the other annular seal part.

In the present invention, the pair of coupling pieces can be configured to extend respectively from the annular seal parts in directions facing each other, close to the enlarged part. In this embodiment, the extending direction of the coupling piece from each annular seal part around the enlarged part crosses with each other. Thus, in case of a simultaneous molding, the materials flow from facing directions in a spiral pattern into the same direction, are mixed together and jointed on the substantially large joint area, thereby enhancing the joint strength. When the materials flow in a spiral pattern into the same direction and are mixed with each other, the flow strength of the materials is further alleviated and the material of one annular seal part is effectively inhibited from entering the other annular seal part.

In the present invention, the annular seal parts coupled by the coupling part having the joint part can be made of different rubber materials, the same cross-linking agent being contained in the different rubber materials.

In this embodiment, the strength of the joint part is further enhanced and the annular seal parts do not separate during storage, conveyance and assembly, thereby improving handling performance.

### Advantageous Effects of Invention

In the gasket of the present invention, a plurality of annular seal parts which require different quality are able to be integrally constituted with material suitable for the annular seal parts, thereby providing a useful gasket without having annular seal parts causing excessive quality and with relatively low cost. In addition, a plurality of annular seal parts are coupled by the coupling part, thereby improving assembly efficiency, compared with the case when the annular seal parts are separately assembled.

### BRIEF DESCRIPTION OF DRAWINGS

FIG. 1 is a sectional view of an essential part showing when a gasket of the first embodiment of the present invention is provided between two members to be sealed and seals a space therebetween.

FIG. 2 is a fragmentary sectional view along the line A-A of FIG. 1.

FIG. 3a and FIG. 3b are enlarged views diagrammatically showing modifications of the joint part and its vicinity in the area “B” of FIG. 2.

FIG. 4a, FIG. 4b and FIG. 4c are enlarged views diagrammatically showing other modifications of the joint part and its vicinity in the area “B” of FIG. 2.

FIG. 5 is a similar view to FIG. 2 of the gasket of the second embodiment of the present invention.

FIG. 6a, FIG. 6b and FIG. 6c are enlarged views diagrammatically showing modifications of the joint part and its vicinity in the area “C” of FIG. 5.

FIG. 7a and FIG. 7b are enlarged views diagrammatically showing other modifications of the joint part and its vicinity in the area “C” of FIG. 5.

FIG. 8a to FIG. 8d show modifications of the sectional view of the gasket of the present invention corresponding to FIG. 1.

FIG. 9a and FIG. 9b are plan views showing modifications of the outer shape of the gasket of the present invention.

FIG. 10 is a plan view showing other modifications of the outer shape of the gasket of the present invention.

FIG. 11a to FIG. 11e are sectional views showing several shapes of the fragmentary view along the line D-D of FIG. 2.

### DESCRIPTION OF EMBODIMENTS

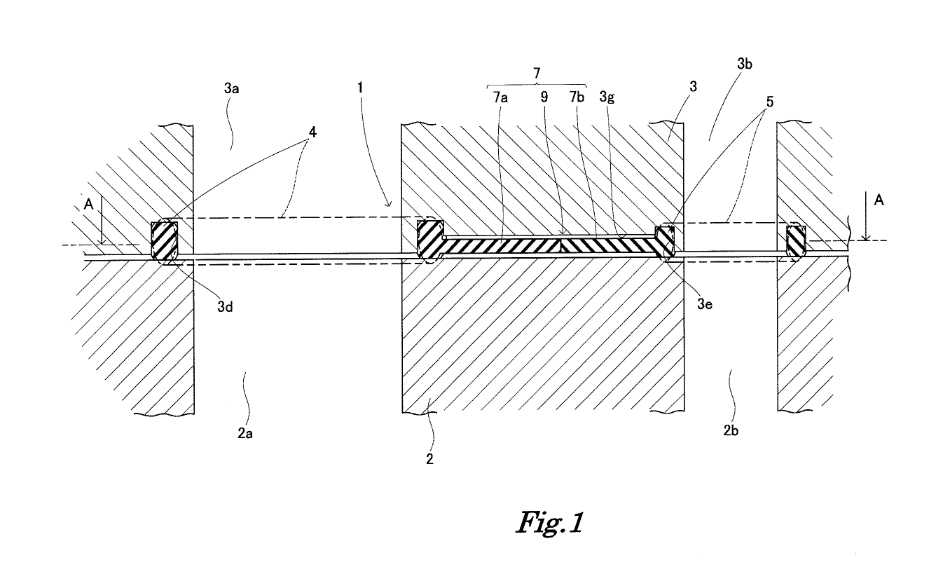

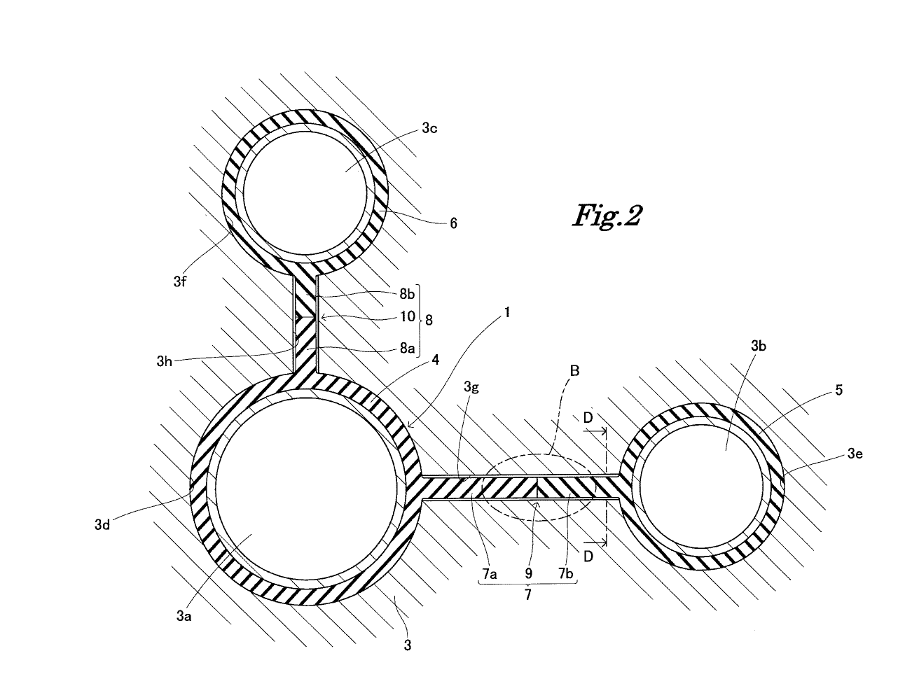

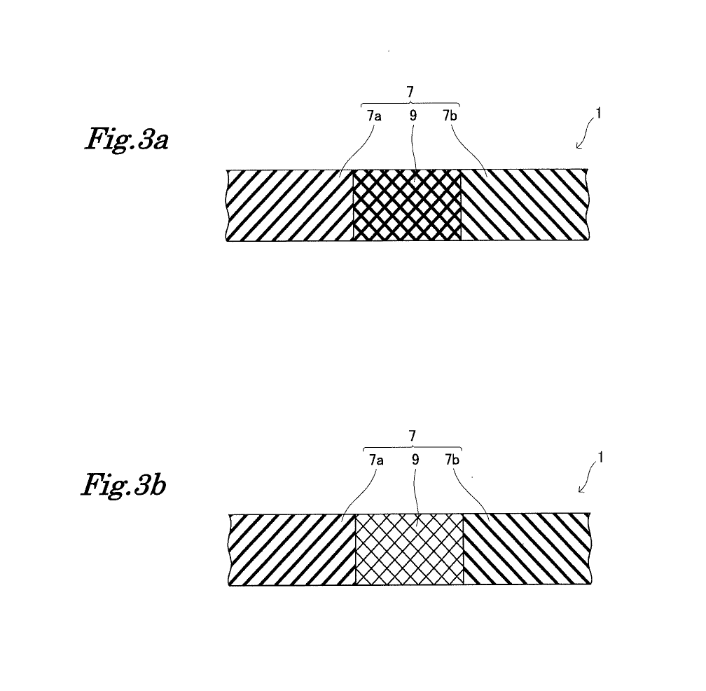

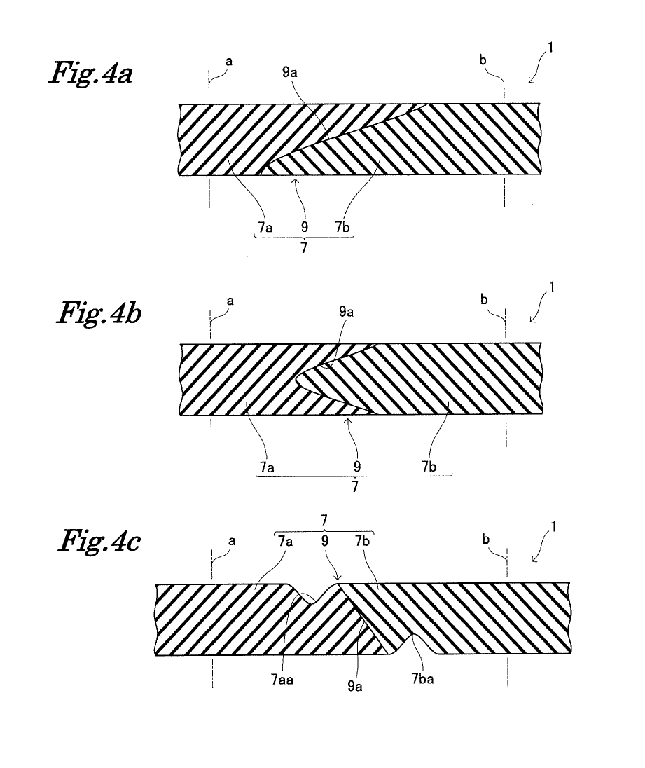

The embodiments of the present invention are explained referring to the attached drawings. FIG. 1 and FIG. 2 show a gasket of the first embodiment of the present invention. FIG. 3 and FIG. 4 show the modifications. A gasket 1 in the embodiments is provided between two members 2, 3 and seals a space therebetween. The two members 2, 3 in the figures are a cylinder block 2 of an engine and an oil cooler 3 which is integrated with the cylinder block 2 by fastening. The two members are not limited to the cylinder block 2 and the oil cooler 3 and can be members which have a plurality of objective regions to be sealed and are provided with a gasket therebetween for sealing a space therebetween. The gasket 1 has a plurality of annular seal parts 4, 5, 6 (three annular seal parts in the figure) and coupling parts 7, 8 for coupling the annular seal parts 4, 5 and the annular seal parts 4, 6, respectively. One annular seal part 4 of the annular seal parts 4, 5, 6 and adjacent two annular seal parts 5, 6 are made of different materials and the coupling parts 7, 8 have joint parts 9, 10 for jointing the different materials, respectively. The gasket 1 of this embodiment including the annular seal parts 4, 5, 6 and the coupling parts 7, 8 is integrally molded with the rubber material to be mentioned later.

The cylinder block 2 has a communication bore 2a for cooling water (antifreeze liquid) and two communication bores 2b for engine oil (one of them is not shown in the figure). The oil cooler 3 has a communication bore 3a for cooling water and communication bores 3b, 3c for oil at the position corresponding to the bores of the cylinder block 2, respectively. The face around the bores 3a, 3b, 3c on the side of the cylinder block 2 has annular concave grooves 3d, 3e, 3f in which the annular seal parts 4, 5, 6 are fitted, respectively. A straight concave groove for coupling 3g is formed between the annular concave grooves 3d, 3e so as to communicate with the annular concave grooves 3d, 3e. A straight concave groove for coupling 3h is formed between the annular concave grooves 3d, 3f so as to communicate with the annular concave grooves 3d, 3f. The depth of the grooves for coupling 3g, 3h is smaller than that of the annular concave grooves 3d, 3e, 3f. The coupling part 7 has a coupling piece 7a extending from the annular seal part 4, a coupling piece 7b extending form the annular seal part 5, and the joint part 9 for jointing the pair of the coupling pieces 7a, 7b. The coupling part 8 has a coupling piece 8a extending from the annular seal part 4, a coupling piece 8b extending from the annular seal part 6, and the joint part 10 for jointing the pair of the coupling pieces 8a, 8b.

The annular seal part 4 is fitted in the annular concave groove 3d formed around the communication bore 3a for cooling water of the oil cooler 3. The annular seal part 5 is fitted in the annular concave groove 3e formed around the communication bore 3b for oil of the oil cooler 3. The annular seal part 6 is fitted in the annular concave groove 3f formed around the communication bore 3c for oil of the oil cooler 3. The annular seal part 4 is exposed to cooling water, so that it is desirably made of a rubber material which is resistant to cooling water such as EPDM, HNBR or FKM. The annular seal parts 5, 6 are exposed to oil, so that it is desirably made of a rubber material which is resistant to oil such as NBR, ACM, FKM, HNBR, CSM or CPE. When the annular seal part is exposed to high-temperature combustion gas including gasoline, it is desirably made of a rubber material which is resistant to high-temperature combustion gas such as FKM, HNBR or FVMQ.

The gasket 1 is produced by simultaneously molding two kinds of rubber materials suitable for the annular seal parts 4, 5(6), respectively. Specifically, two kinds of unvulcanized rubber materials are simultaneously injected from the ends of the cavities, the ends being far from the adjacent annular seal parts, corresponding to the annular seal parts 4, 5, 6, respectively, of the mold having cavities in the shape of a predetermined gasket. Thus, the gasket is integrally formed by vulcanizing the rubber materials. The cavities corresponding to the annular seal parts 4, 5, 6 of the mold are filled with two kinds of rubber materials injected from each injection port, and two kinds of rubber materials flow in the cavities corresponding to the coupling parts 7, 8. The rubber materials flowing in the cavities corresponding to the coupling parts 7, 8 are integrated and face each other. Two rubber materials charged in the cavities corresponding to the annular seal parts 4, 5, 6 are hardened by vulcanization, thereby the annular seal parts 4, 5, 6 are formed. The rubber materials integrated after flowing in the cavities corresponding to the coupling parts 7, 8 are hardened by vulcanization in an integrated condition. Thus, the coupling parts 7, 8 are formed, the coupling parts 7, 8 having the coupling pieces 7a, 7b, 8a, 8b extending from the annular seal parts 4, 5, 6 and having the joint parts 9, 10, wherein the coupling pieces 7a, 7b, 8a, 8b are jointed as mentioned above.

When the rubber materials of the annular seal parts 4, 5, 6 are different and the external colors thereof are different by changing a coloring agent depending on the medium to be sealed, position corresponding to the annular seal parts 4, 5, 6, respectively, is easily confirmed at the time of assembly. Thus, assembly, to be mentioned later, is facilitated and done effectively. In addition, the coupled annular seal parts 4, 5 and the coupled annular seal parts 4, 6 which are made of different materials are desirably molded from different rubber materials, the same cross-linking agent being contained in the different rubber materials. The cross-linking agent is peroxide for a combination of HNBR and EPDM, and the cross-linking agent is diamine compound for a combination of ACM and HNBR. The unvulcanized different rubber materials are well fit at the joint parts 9, 10 by the cross-linking agent and are strongly jointed at the time of hardening by vulcanization.

The above-mentioned gasket 1 is provided between the cylinder block 2 and the oil cooler 3 and seals a space between the cylinder block 2 and the oil cooler 3. The annular seal parts 4, 5, 6 are fitted in the annular concave grooves 3d, 3e, 3f of the oil cooler 3, respectively, and the coupling parts 7, 8 are fitted in the concave grooves for coupling 3g, 3h, respectively. The cylinder block 2 and the oil cooler 3 assembled with the gasket 1 by fitting are integrated and fastened with each other with a bolt (not shown). The annular seal parts 4, 5, 6 in the figures have elliptical sections and are formed in such a manner that the longer diameter is in the fastening direction. The longer diameters of the annular seal parts 4, 5, 6 are determined in such a manner that the annular seal parts 4, 5, 6 are compressed between the upper face of the cylinder block 2 and the bottoms of the annular concave grooves 3d, 3e, 3f, respectively, at the time of fastening. The shorter diameters of the annular seal parts 4, 5, 6 are smaller than the groove widths of the annular concave grooves 3d, 3e, 3f, respectively. FIG. 1 shows that the cylinder block 2 and the oil cooler 3 are appropriately fastened. Two dotted lines in FIG. 1 show the original shape of the annular seal parts 4, 5, 6. The annular seal parts 4, 5, 6 are compressed and elastically deformed to fill the annular concave grooves 3d, 3e, 3f like the solid lines, respectively. The width of the coupling parts 7, 8 is smaller than that of the concave grooves for coupling 3g, 3h. The thickness of the coupling parts 7, 8 is set so as not to be compressed between the upper face of the cylinder block 2 and the bottoms of the concave grooves for coupling 3g, 3h under the above-mentioned fastened condition.

The annular seal parts 4, 5, 6 are compressed around each bore being the objective regions to be sealed, between the fastened cylinder block 2 and the oil cooler 3, thereby the objective regions are sealed. The annular seal parts 4, 5, 6 are made of a rubber material suitable for the objective medium to be sealed in the objective region to be sealed, respectively, so that there are no annular seal part with unnecessary quality and the production cost of the gasket 1 does not increase. The coupling parts 7, 8 do not affect the seal performance of the gasket 1 and are not compressed at the time of fastening, so that the coupling parts 7, 8 do not affect the seal performance by compression of the annular seal parts 4, 5, 6, thereby successfully keeping the seal performance of the gasket 1 for a long time. Three annular seal parts 4, 5, 6 are integrally coupled with the coupling parts 7, 8, so that the integrally formed gasket 1 is superior in storage performance and transportation performance to the case when the annular seal parts are separately produced, thereby the gasket 1 is able to be effectively assembled with the cylinder block 2 and the oil cooler 3.

FIG. 3a and FIG. 3b are enlarged views diagrammatically showing modifications of the joint part 9 and its vicinity in the area “B” of FIG. 2. FIG. 3a and FIG. 3b show two specific examples wherein the joint part 9 is made of a material different from the rubber materials of the annular seal parts 4, 5. The example of FIG. 3a shows that a mixture of a rubber material of the annular seal part 4 (coupling piece 7a) and a rubber material of the annular seal part 5 (coupling piece 7b) is prepared in advance on the region of the mold corresponding to the joint part 9 at the time of simultaneous molding. Then each rubber material is simultaneously injected and vulcanized, thereby forming the joint part 9. The example of FIG. 3b shows that a rubber material different from those for the annular seal part 4 (coupling piece 7a) and the annular seal part 5 (coupling piece 7b) is prepared in advance on the region of the mold corresponding to the joint part 9 in case of simultaneous molding. Then each rubber material is simultaneously injected and vulcanized, thereby forming the joint part 9. In FIG. 3a, the joint part 9 is formed with the mixture of the rubber materials of the annular seal parts 4, 5, so that the joint part 9 well fits the coupling pieces 7a, 7b extending from the annular seal parts 4, 5, respectively and the coupling pieces 7a, 7b are strongly jointed via the joint part 9. In FIG. 3b, the joint part 9 is formed with the third rubber material different from the rubber materials of the annular seal parts 4, 5, so that the coupling pieces 7a, 7b are strongly jointed via the joint part 9 by selecting the third rubber material which fits the rubber materials of the annular seal parts 4, 5. The joint part 9 is provided for a region which does not affect the seal performance of the annular seal parts 4, 5, so that the strength of the joint part 9 increases without deteriorating seal ability by selecting a material having strong joint strength without considering seal ability. The joint part 10 shown in FIG. 2 is constituted in the same manner and the coupling pieces 8a, 8b are strongly jointed. In FIG. 3a and FIG. 3b, the material of the joint part 9 can be simultaneously injected as the third material at the time of simultaneous molding of the rubber materials of the annular seal parts 4, 5 and the joint part 9 can be constituted.

FIG. 4a, FIG. 4b and FIG. 4c are enlarged views diagrammatically showing other modifications of the joint part 9 and its vicinity in the area “B” of FIG. 2. FIG. 4a, FIG. 4b, FIG. 4c show three specific examples wherein a pair of the coupling pieces 7a, 7b is jointed in the joint part 9 with a larger area than the sectional area of the coupling pieces 7a, 7b. In FIG. 4a, the coupling pieces 7a, 7b are jointed in such a manner that they slide to each other, thereby forming the joint part 9. In FIG. 4b, the coupling pieces 7a, 7b are jointed in such a manner that one coupling piece 7b cuts into the other coupling piece 7a, thereby forming the joint part 9. In FIG. 4c, the coupling pieces 7a, 7b have constricted parts 7aa, 7ba on the facing sides close to the joint part 9. The constricted parts 7aa, 7ab are formed by the shape of the cavities of the mold for simultaneous molding. The flow pressures of the rubber materials of the annular seal parts 4, 5 function in a crossing manner at the time of simultaneous molding, thereby forming the joint part 9 wherein the coupling pieces 7a, 7b are jointed in such a manner that they slide to each other.

As shown in the joint manners of FIG. 4a, FIG. 4b, FIG. 4c, the coupling pieces 7a, 7b are jointed in the joint part 9 with a larger area than each sectional area. Specifically, the coupling pieces 7a, 7b are jointed in such a manner that the area of a joint surface 9a of the joint part 9 is larger than the sectional area of the coupling pieces 7a, 7b along the transversal lines a, b, respectively, the sectional areas thereof being the same in the area in the figures. When the coupling pieces 7a, 7b are jointed with a large area, the joint strength increases. In FIG. 4c, the constricted parts 7aa, 7ab are provided so that the stress applied on the coupling piece concentrates on the constricted parts 7aa, 7ab, thereby alleviating the stress applied on the joint part 9. As a result, the durability of the joint part 9 is improved. The joint part 10 shown in FIG. 2 is constituted in the same manner and the coupling pieces 8a, 8b are strongly jointed.

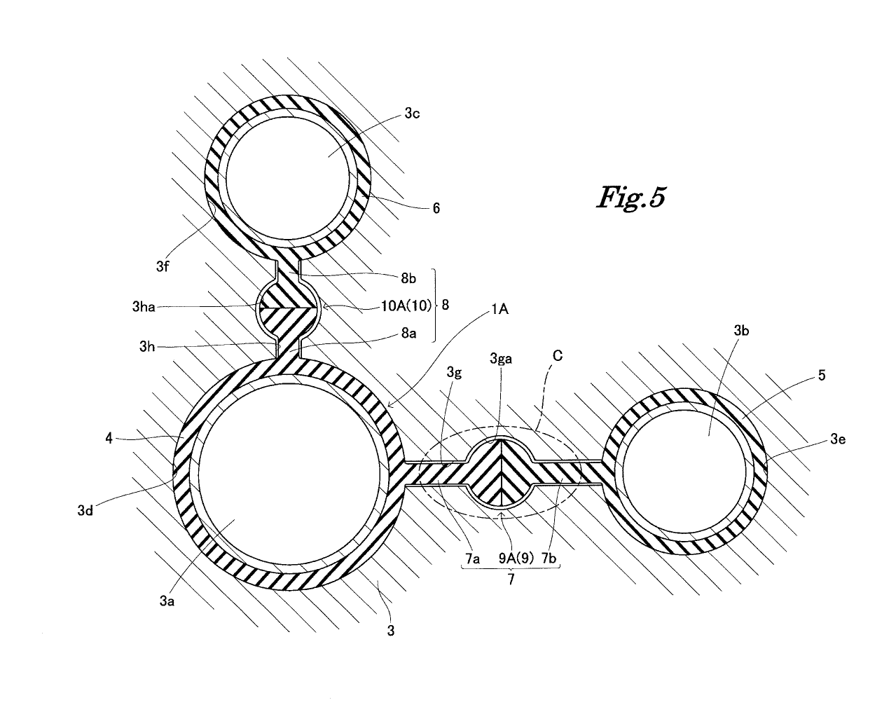

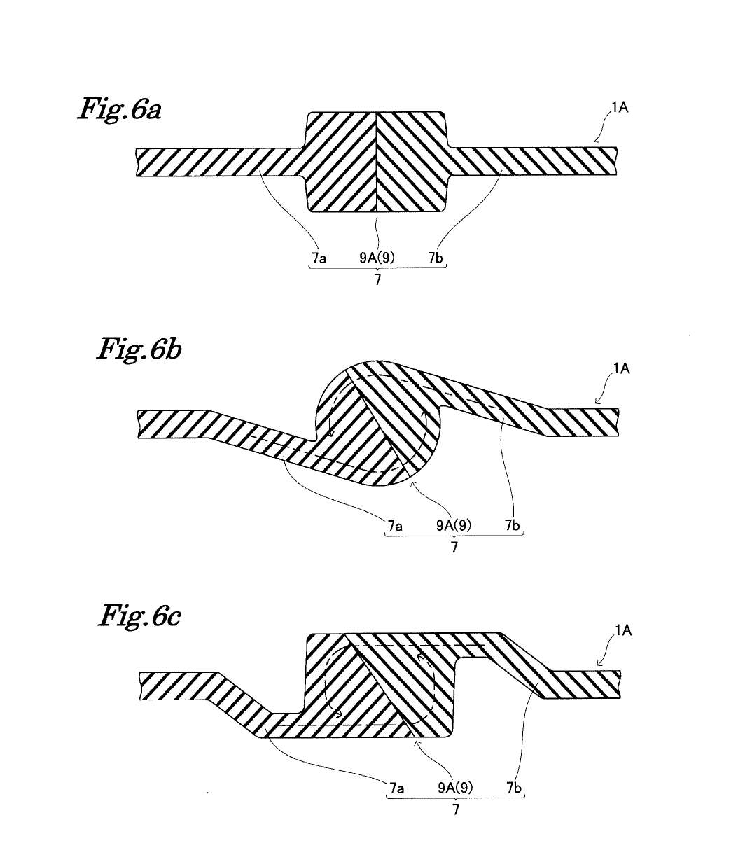

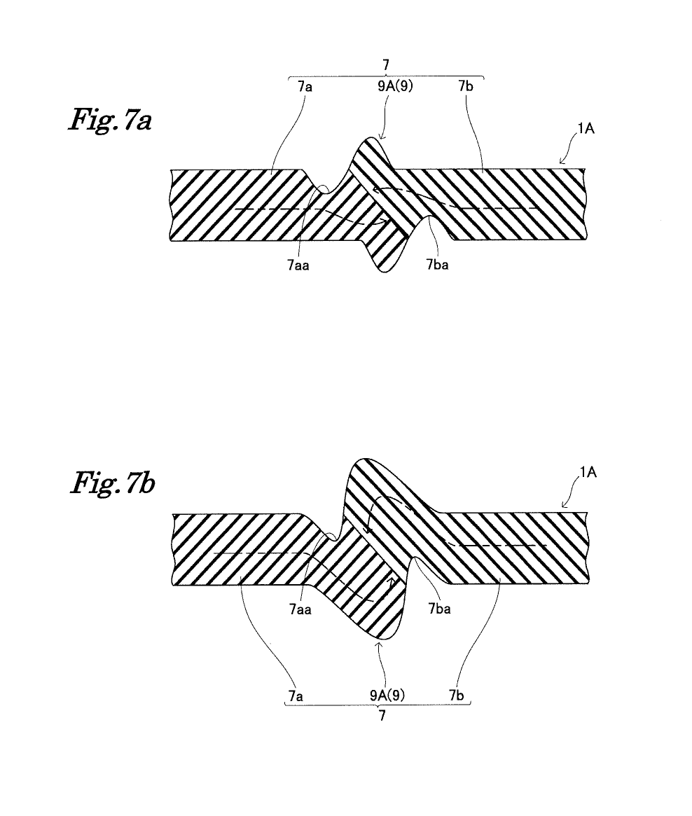

FIG. 5 shows the gasket of second embodiment of the present invention. FIG. 6 and FIG. 7 show the modifications. A gasket 1A of the embodiment has annular seal parts 4, 5, 6 and coupling parts 7, 8 coupling the annular seal parts 4, 6 and the annular seal parts 4, 6, respectively. One annular seal part 4 of the annular seal parts 4, 5, 6 is made of a different material from the two adjacent annular seal parts 5, 6 and the coupling parts 7, 8 have the joint parts 9, 10 for jointing the different materials. The joint parts 9, 10 comprise enlarged parts 9A, 10A having larger sectional area than the coupling pieces 7a, 7b and the coupling pieces 8a, 8b, respectively.

The gasket 1A is formed by simultaneously molding two kinds of rubber materials suitable for the annular seal parts 4, 5 (6), respectively, like the gasket 1 of the first embodiment. The enlarged parts 9A, 10A in FIG. 5 are substantially circular on the plane view. Different rubber materials are integrated so as to face each other at the cavities of the mold corresponding to the enlarged parts 9A, 10A at the time of simultaneous molding and some of the materials are mixed. The rubber materials are integrated with large facing surfaces at the cavities, so that the joint area increases after hardening by vulcanization and the rubber materials are strongly jointed. At the time of simultaneous molding, the flow strength of the rubber materials is alleviated by enlarged cavities and one material of one annular seal part is inhibited from entering the other material of the other annular seal part.

As shown in FIG. 5, the gasket 1A mentioned above is fitted in the annular concave grooves 3d, 3e, 3f and the concave grooves for coupling 3g, 3h of the oil cooler 3; and the cylinder block (referring to FIG. 2) and the oil cooler 3 are integrally fastened. The gasket 1A is provided under pressure between the cylinder block 2 and the oil cooler 3 as mentioned above, thereby sealing the cylinder block 2 and the oil cooler 3. The concave grooves for coupling 3d, 3h are formed with substantially circular wide parts 3ga, 3ha capable of receiving the enlarged parts 9A, 10A, respectively.

FIG. 6a, FIG. 6b and FIG. 6c are modifications of the gasket 1A of the second embodiment of the present invention and are enlarged views diagrammatically showing the part corresponding to the area “C” of FIG. 5. In FIG. 6a, the shape of the enlarged part 9A is substantially in the form of rectangule of which long side is along the longitudinal direction of the coupling part 7 and such a modification has a similar effect to that of the embodiment of FIG. 5. In FIG. 6b, the shape of the enlarged part 9A is substantially circular like FIG. 5. However, the coupling pieces 7a, 7b extend from the annular seal parts 4, 5 along the tangent lines of the circular enlarged part 9A in the vicinity of the enlarged part 9A, respectively and the coupling pieces 7a, 7b are formed in parallel in the facing directions. Because of the shapes of the coupling pieces 7a, 7b and the enlarged part 9A, rubber materials flow into the cavity of the mold corresponding to the enlarged part 9A along the two-dotted lines in FIG. 6b when the gasket 1A is formed by simultaneously molding the different rubber materials as mentioned above. As a result, the different rubber materials flow into the cavity in a spiral pattern in the same direction and are mixed together, thereby obtaining a strongly jointed joint part 9 after hardening by vulcanization.

In FIG. 6c, the shape of the enlarged part 9A is substantially rectangular like FIG. 6a. The coupling pieces 7a, 7b extend from the annular seal parts 4, 5 along the long side direction of the rectangular enlarged part 9A, respectively in the vicinity of the enlarged part 9A and the coupling pieces 7a, 7b are formed in parallel in the facing directions. Like FIG. 6b, the rubber materials flow into the cavity of the mold corresponding to the enlarged part 9A of the mold in a spiral pattern into the same direction at the time of simultaneous molding. The materials are mixed together and a strongly jointed joint part 9 is obtained after hardening by vulcanization.

The modifications in FIG. 6b, FIG. 6c are preferably used because the modifications have the above-mentioned advantageous effects (mixing in a spiral pattern) in addition to the advantageous effects of the embodiment of FIG. 5 or FIG. 6a. When the modifications shown in FIG. 6a, 6b, 6c are applied to the joint part 10 in FIG. 5, the coupling pieces 8a, 8b are strongly jointed.

FIG. 7a and FIG. 7b are other modifications of the gasket 1A of the second embodiment and are enlarged views diagrammatically showing the part corresponding to the area “C” of FIG. 5. The joint part is formed with a wavy enlarged part 9A in the modifications and the width of the joint part 9 is substantially enlarged between the tops of the waves. In addition, the coupling pieces 7a, 7b have the constricted parts 7aa, 7ba on the facing sides in the vicinity of the joint part 9, respectively, like FIG. 4c. By the wavy shape of the enlarged part 9A and the constricted parts 7aa, 7ba, the coupling pieces 7a, 7b extend from the annular seal parts 4, 5 on the facing sides in the vicinity of the area of the enlarged part 9A.

Like FIG. 6b and FIG. 6c, when the gasket 1A is formed by simultaneously molding different rubber materials as mentioned above, the rubber materials flow into the cavity of the mold corresponding to the enlarged part 9A along the two-dotted lines. As a result, the rubber materials flow in a spiral pattern in the same direction from the facing positions and are mixed together, thereby obtaining a strongly jointed joint part 9 after hardening by vulcanization. In addition, because of the constricted parts 7aa, 7ba, the stress applied on the coupling part 7 concentrates on the constricted parts 7aa, 7ba, thereby alleviating the stress applied on the joint part 9 like FIG. 4c. As a result, the resistance property of the joint part 9 is improved.

The modifications in FIG. 7a and FIG. 7b are preferably used because the modifications have the above-mentioned advantageous effects in addition to the advantageous effects of the embodiment of FIG. 5 or FIG. 6a. When the modifications shown in FIG. 7a and FIG. 7b are applied to the joint part 10 in FIG. 5, the coupling pieces 8a, 8b are strongly jointed.

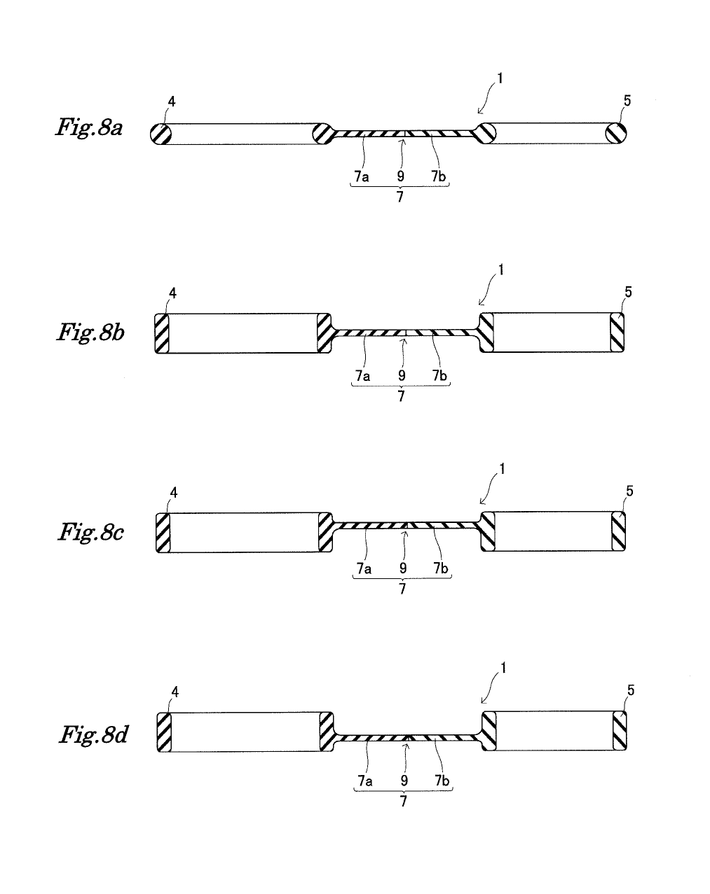

FIG. 8a to FIG. 8d show the modifications of the sectional view of the gasket of the present invention corresponding to FIG. 1. The figures show various sectional shapes of the annular seal part and various extending positions of the coupling parts from the annular seal part. The figures are applicable to the first and the second embodiments. In FIG. 8a, the sectional shapes of the annular seal parts 4, 5 are substantially circular and the coupling pieces 7a, 7b of the coupling part 7 extend from almost middle positions of the annular seal parts 4, 5 in the fastening directions between the cylinder block 2 and the oil cooler 3. In FIG. 8b, FIG. 8c and FIG. 8d, the sectional shapes of the annular seal parts 4, 5 are substantially rectangular and the long sides thereof are formed in the fastening direction. In FIG. 7b, the coupling pieces 7a, 7b extend from almost middle positions of the annular seal parts 4, 5 in the fastening direction. In FIG. 7c, the coupling pieces 7a, 7b extend from the upper positions (in the bottom side position of the annular concave grooves 3d to 3f) of the annular seal parts 4, 5 in the fastening direction. In FIG. 7d, the coupling pieces 7a, 7b extend from the lower positions (in the open side position of the annular concave grooves 3d to 3f) of the annular seal parts 4, 5 in the fastening direction.

Such modifications are selectively applied depending on the product specification and ease of molding. The sectional shapes of the annular seal parts 4, 6 and the coupling part 8 in FIG. 2 and FIG. 5 can be formed in the same manner. In addition, the sectional shape of the annular seal part is not limited to the above and the shape can be unsymmetric vertically or horizontally.

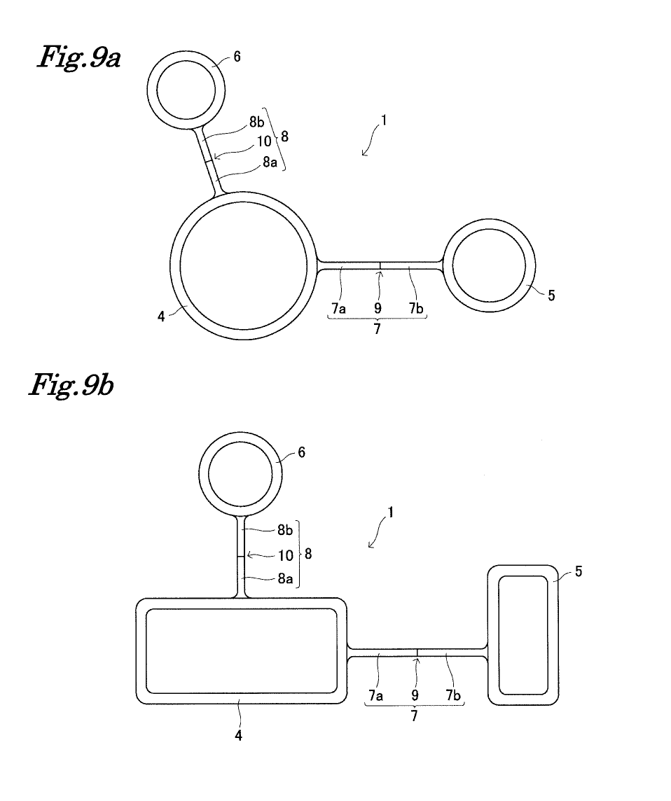

FIG. 9a and FIG. 9b are plan views showing the modifications of the outer shape of the gasket of the present invention. The modifications are applicable to the first and second embodiments. The modifications show that the shape of the gasket of the present invention is determined depending on the shape and the positional relation of the object to be sealed between two objects to be sealed. Therefore, in addition to the shapes shown in the figures, other shapes are possible and the number of the annular seal parts is not limited to three, namely the number can be two or more than three. In the figures, the same reference numerals are allotted to the common members of the above-mentioned embodiments and their explanation is omitted here.

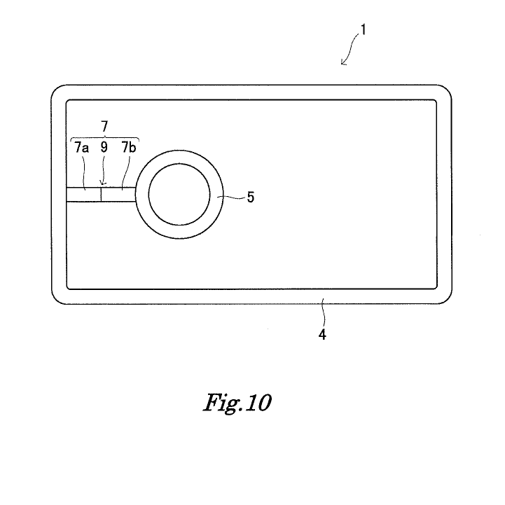

FIG. 10 is a plan view showing other modification of the outer shape of the gasket of the present invention. The modification is also applicable to the first and second embodiment. The gasket 1 in the modification is formed with the large annular seal part 4 and the small annular seal part 5 provided in the annular shape of the seal part 4. The annular seal parts 4, 5 are made of different rubber materials as mentioned above and are jointed by the coupling part 7 formed by jointing the coupling pieces 7a, 7b via the joint part 9. Such a gasket 1 has the same advantageous effects as the above-mentioned embodiments.

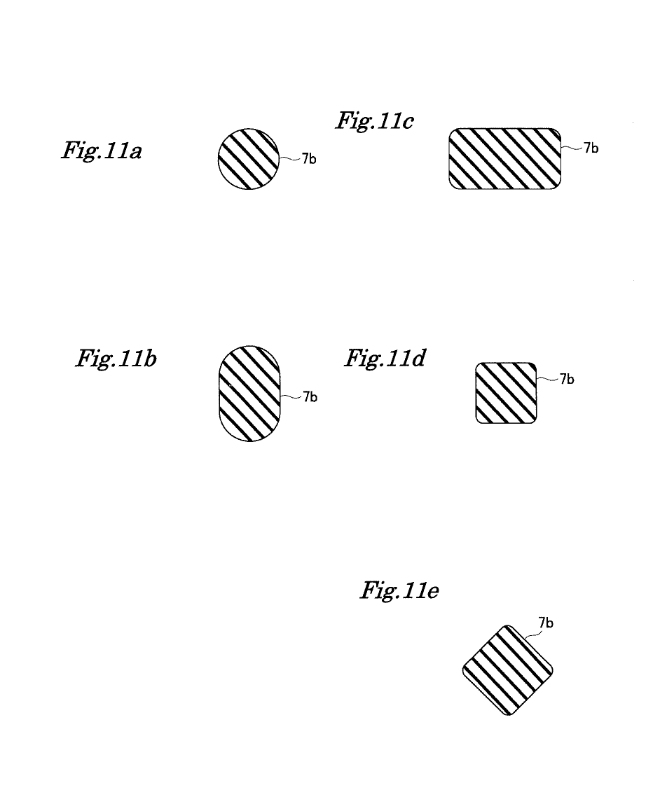

FIG. 11a to FIG. 11e are sectional views showing other shapes of the fragmentary view along the line D-D of FIG. 2 and are also applicable to the first and second embodiments. The modifications show possible sectional shapes of the coupling piece of the coupling part. The coupling part does not affect the seal performance of the gasket of the present invention, so that the shape is selectively applied considering coupling strength, ease of molding or handling ability rather than seal ability.

In the above-mentioned embodiments, the annular seal parts 4, 5, 6 are made of different rubber materials. However, when the annular seal parts to be coupled require common quality, the annular seal parts to be coupled can be made of the same rubber material. In the above-mentioned embodiments, the two members exemplify the cylinder block 2 and the oil cooler 3. However, the present invention is not limited to the above and the gasket of the present invention is preferably used when there are a plurality of objects to be sealed and the qualities required for the gasket materials are different for the medium to be sealed. The figures show that the different rubber materials joint on a clear boundary surface for easy understanding; however, the joint part has some width and such a clear boundary surface does not exist. In the above-mentioned embodiments, the material of the gasket is rubber; however, the material can be elastomer of various kinds including soft synthetic resin and so on.

### REFERENCE SIGNS LIST

1, 1A gasket
2 cylinder block (one of two members)
3 oil cooler (the other of two members)
4, 5, 6 annular seal part
7, 8 coupling part
7a, 7b coupling piece
7aa, 7ba constricted part
8a, 8b coupling piece
9, 9A joint part
10, 10A joint part

1. A gasket provided between two members and configured to seal a space therebetween, the gasket comprising:
a plurality of annular seal parts;
a coupling part configured to couple the annular seal parts;
at least one of the annular seal parts and the other annular seal parts coupled with the one annular seal part being made of different materials, and
the coupling part configured to couple the annular seal parts made of different materials, the coupling part having a joint part configured to joint the different materials.

2. The gasket as set forth in claim 1, wherein the annular seal parts made of different materials are of different exterior colors.

3. The gasket as set forth in claim 1, wherein the coupling part configured to couple the annular seal parts made of different materials comprises a pair of coupling pieces extending from each annular seal part and the joint part configured to joint the coupling pieces.

4. The gasket as set forth in claim 3, wherein the joint part is made of a material different from that of the coupling pieces.

5. The gasket as set forth in claim 3, wherein the pair of coupling pieces is jointed with a larger area than the sectional area of the coupling piece.

6. The gasket as set forth in claim 5, wherein the pair of coupling pieces has constricted parts, respectively, the constricted parts facing each other relative to the joint part and being provided close to the joint part.

7. The gasket as set forth in claim 5, wherein the coupling part is formed with an enlarged part, the enlarged part being larger than the coupling pieces in the sectional area.

8. The gasket as set forth in claim 7, wherein the pair of coupling pieces is configured to extend respectively from the annular seal parts in directions facing each other, close to the enlarged part.

9. The gasket as set forth in claim 1, wherein the annular seal parts coupled by the coupling part having the joint part are made of different rubber materials, the same cross-linking agent being contained in the different rubber materials.
